(19) United States
(12) Patent Application Publication
(10) Pub. No.: US 2011/0209349 A1
(43) Pub. Date: Sep. 1, 2011

(54) SHAVING APPARATUS

(75) Inventor: Richard Wayne Bryan, Manurewa (NZ)

(73) Assignee: CLOSE CUT CO LIMITED, Manukau (NZ)

(21) Appl. No.: 13/129,116

(22) PCT Filed: Nov. 13, 2008
(86) PCT No.: PCT/NZ08/00304

§ 371 Date: May 12, 2011

(30) Foreign Application Priority Data
Nov. 13, 2007 (NZ) 563383

(51) Int. Cl. B26B 21/22; B26B 21/54

(52) U.S. Cl. 30/32; 30/346.57

(57) ABSTRACT

A manual shaving apparatus comprising plurality of blade stacks. Each said blade stack comprises a plurality of identical blades. Each blade includes at least two cutting edges. The blades in each stack are orientated to be in register with each other. Each blade in a stack is arranged to allow rotation about a common axis and to present a cutting edge of each blade in each stack in a common plane.

### FIELD OF THE INVENTION

The present invention relates to shaving apparatus and/or blade unit for a shaving apparatus, preferably but not solely of a disposable kind.

### BACKGROUND

Commonly manual shaving apparatus have a head that holds one or more razor blades fixed in place for shaving. After repeated use, the razor blades may become blunt, and therefore not as effective at cutting hair. When the razor blades become blunt, the manual shaver may be discarded, or alternatively the head may be replaced with a new blade unit having new razor blades.

There is a substantial cost associated with constant replacement of razor blade units and/or an entire shaving razor apparatus (including the handle) every time the razor blades become blunt. Many people have to replace the entire razor, or the blade unit multiple times per month.

Furthermore, there are environmental issues associated with constant disposal of razors, and razor related parts. Less frequent disposal of shaver and shaver related parts would benefit the environment insofar as there would be less waste to dispose of. It would be desirable if a shaver could be used for longer periods of time, without the need to discard the razor blades and/or the entire shaver as frequently.

Manual razors commonly have one, two, three, or four blades arranged parallel on the razor head. Multiple blades may aid in removing more hair, and give a closer shave. However, once blunt the razor blade unit needs to be disposed and replaced.

Accordingly, it is an object of the present invention to provide a shaving apparatus which overcomes or at least ameliorates some of the abovementioned disadvantages or which at least provides the public with a useful choice.

### BRIEF DESCRIPTION OF THE INVENTION

In a first aspect the present invention consists of a manual shaving apparatus comprising:

a plurality of blade stacks, each said blade stack comprises a plurality of identical blades each blade including at least two cutting edges, the blades in each stack are orientated to be in register with each other, and each blade in a stack is arranged to allow rotation about a common axis and to present a cutting edge of each blade in each stack in a common plane.

Preferably an adjuster is provided to simultaneously rotate the blade stacks about their respective axis.

Preferably said adjuster comprises a gear train, and an input actuator.

Preferably each said blade stack has a gear located thereon, each gear adapted to be rotatable about each said axis.

Preferably each said gear of each said blade stack is operatively engaged with an adjacent gear of an adjacent blade stack to form said gear train.

Preferably rotation of one said gear will transfer rotational torque to each said gear located in said gear train.

Preferably said input actuator can be rotated by a user to cause said gears in said gear train to rotate.

Preferably said input actuator can be actuated by a user to cause rotation of said gears on said gear train,

wherein, rotation of said gears in said gear train results in rotation of said blade stacks.

Preferably said input actuator can be rotated to cause said blade stacks to be rotated to a different orientation.

Preferably each said blade is polygonal in plan shape.

Preferably each said blade has at least three cutting edges.

Preferably each cutting edge is defined by a side of the polygon of the polygonal shaped blade.

Preferably each said blade is pentagonal in plan shape.

Preferably said cutting edges are bevelled.

Preferably there is a space between each said blade of each said blade stack.

Preferably the blades in each stack are in an overlapping relationship with blades of an adjacent stack, when viewed in a direction parallel to the common axis.

Preferably blades in each stack nest within the space between the blades of an adjacent stack.

Preferably the stacks of blades are held by a housing and are mounted relative thereto in a rotatable manner each about its respective common axis.

Preferably the housing holds and each stack of blades and envelops each blade save for at one region of each stack at where one cutting edge of each blade in each stack is exposed and presented to allow the blades to be utilised for shaving.

Preferably the shaving apparatus is of a disposable kind.

In a second aspect the present invention consists in a shaving apparatus comprising:

a blade stack comprises a plurality of identical razor blades each including at least two cutting edges, wherein each razor blade in said stack is supported by a common axle that is rotatable about an axis of rotation to present a cutting edge of each razor blade in a common plane with a cutting edge of all the other razor blades in the blade stack.

In a further aspect the present invention consists in a razor blade unit for use in a manual shaving apparatus comprising:

a housing that holds a blade stack comprises a plurality of identical razor blades each including at least two cutting edges, each razor blade in said stack supported by a common axle that is rotatable about an axis of rotation relative to the housing to rotate the razor blades in the blade stack in unison to allow sequential presentation of each cutting edge of each razor blade for shaving, in a manner such that a cutting edge of all the other razor blades in the blade stack are presented in a common plane.

In even a further aspect the present invention consists in a disposable razor blade unit for engagement to a manual shaving apparatus handle said disposable razor blade unit comprising:
a. housing,
b. at least one array of planar razor blades arranged on a common axle wherein each razor blade is supported on said common axle parallel to each other and spaced apart from each other, each razor blade including at least at first cutting edge and a second cutting edge, the first cutting edge of each razor blade positioned such that is it located on a plane with which all first cutting edges of each razor blade are coincident, the second cutting edge of each razor blade positioned such that is it located on a plane with which all second cutting edges of each razor blade are coincident,
c. a driver actuable by a digit of a user connected to said common axle whereby the user can rotate said common axle relative to said housing to rotate the array and selectively present one of the first cutting edge and second cutting edge of each razor blade of the array for use in shaving.

Preferably the housing supports said common axle.

Preferably a plurality of arrays are provided each arranged on a common axle, each axle mounted relative to said housing parallel to each other, wherein each cutting edge of each array can be positioned to reside in a common plane for presentation for shaving.

In yet a further aspect the present invention consists in a shaving apparatus comprising a handle for grasping by a user and a disposable razor blade unit as cheering before described, removably engaged to said handle.

In even a further aspect the present invention consists in, as a kit, a shaving apparatus comprising a handle for grasping by a user and a disposable razor blade unit as herein before described capable of removable engagement to said handle.

In even a further aspect the present invention consists in a shaving apparatus as herein described with reference to one or more of the accompanying drawings.

In even a further aspect the present invention consists a razor blade unit as herein described with reference to one or more of the accompanying drawings

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1 is a perspective view of a shaving apparatus of the present invention,

FIG. 2 is a rear perspective view of a set of blade stacks for a razor blade unit,

FIG. 3 is a front perspective view of a set of blade stacks for a razor blade unit,

FIG. 4 is a rear view of a set of blade stacks for a razor blade unit,

FIG. 5 is a side view of a set of blade stacks for a razor blade unit

FIG. 6 is a plan view of a set of blade stacks for a razor blade unit, and

FIG. 7 is a perspective view of an alternative embodiment of the present invention, in which the blade unit uses four sided blades,

FIG. 8 is another perspective view of the shaving apparatus of FIG. 7,

FIG. 9 is an isometric view of a razor blade unit of an alternative embodiment of the present invention having four sided blades located thereon,

FIG. 10 is a front view of the razor blade unit of FIG. 9,

FIG. 11 is a rear perspective view of the razor blade unit of FIG. 9 showing the gear train,

FIG. 12 is a plan view of the razor blade unit of FIG. 9 showing the locations of the cross-sections C-C and D-D.

FIG. 13 is a cross-sectional view of FIG. 12 through D-D.

FIG. 14 is a cross-sectional view of FIG. 13 through C-C.

### DETAILED DESCRIPTION OF THE INVENTION

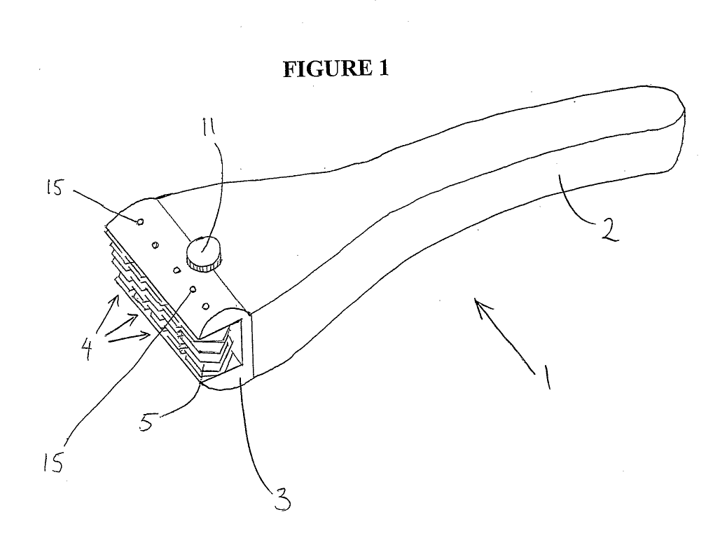

With reference to FIG. 1 there is shown a manual shaving apparatus 1. The manual shaving apparatus 1 has a handle 2 which may be manufactured by injection moulding plastic. Alternatively, the handle may be any other suitable material and manufactured using any other suitable manufacturing process.

There is a razor blade unit 3 located at the end of the handle. The razor blade unit 3 may be manufactured separately from the handle 2 and then rigidly fixed to the handle 2. Alternatively, the razor blade unit 3 may be manufacture with the handle, or a part of the handle, as a unitary item.

The razor blade unit 3 includes a number of blade stacks 4 arranged adjacent to one another. Preferably there are five blade stacks 4, however there may be any number of blade stacks 4. Each blade stack 4 may contain at least one blade 5. There are preferably six blades 5 located on each blade stack 4, however there may be any number of blades 5.

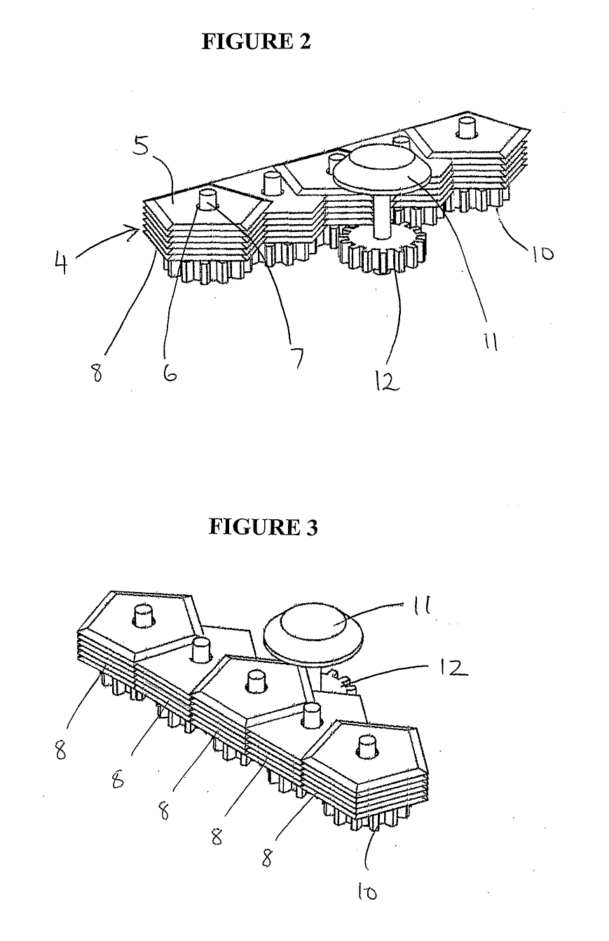

The blades 5 may be of a polygonal shape. The edges of each blade are, preferably straight. Preferably the blades 5 are of a pentagonal shape as shown in FIG. 2. A hole 6 at the centre of each blade 5 allows each blade 5 to register with a shaft 7. The blades may be stacked on top of each other on the shaft 7 as shown in FIG. 2 and are preferably in the same orientation with one another with respect to the shaft 7. Therefore each edge 8 is parallel with the corresponding edges 8 of adjacent blades in a blade stack 4. Furthermore, all of the edges 8 lie in the same plane as the corresponding edges 8 of blades in adjacent blade stacks 4.

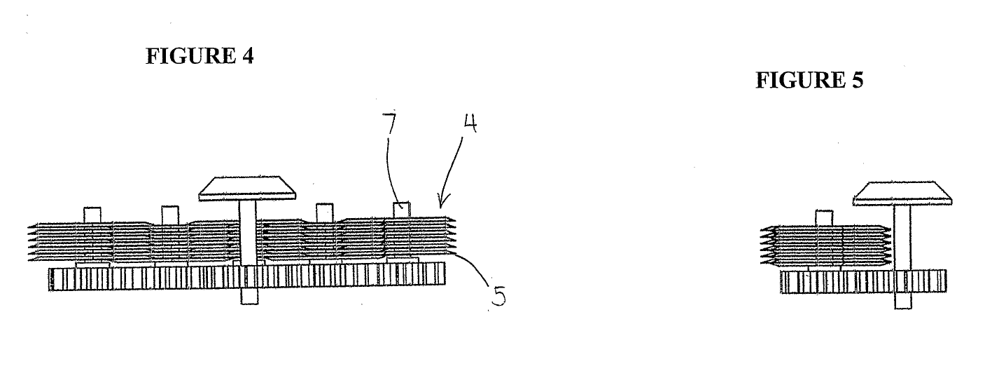

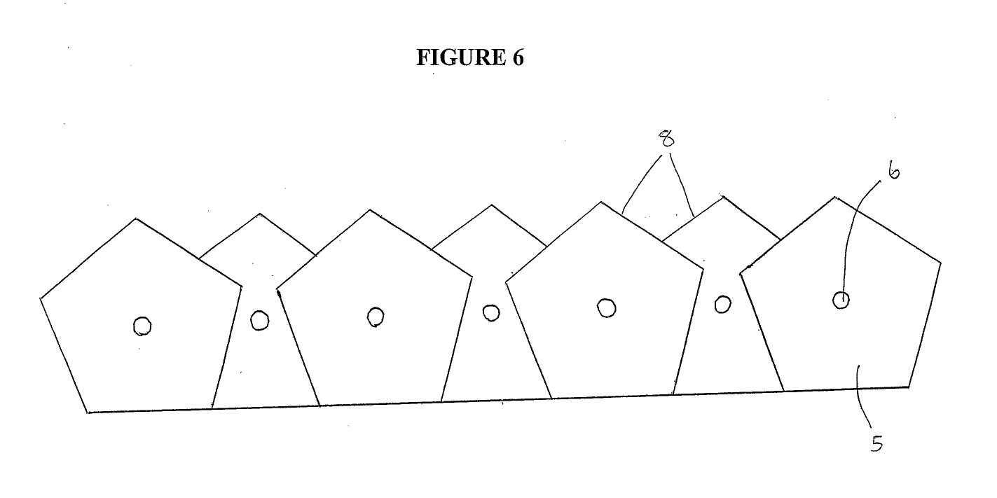

FIG. 6 shows that the blades 5 in each blade stack 4 may be in an overlapping relationship with the blades 5 of an adjacent blade stack 4. FIG. 4 shows that the blades 5 in each blade stack 4 have a space between them. This allows for the blades 5 to nest in the space between the blades 5 on an adjacent stack.

The nested blades 5 may be orientated as shown in FIG. 3. In this orientation, the exposed cutting edges 8 of each blade stack 4 are parallel with all of the blades in the same blade stack 4, and also parallel with the exposed cutting edges 8 of all of the blades in the adjacent blade stacks. This orientation creates an arrangement of exposed cutting edges 8, all in the same plane, for use in shaving.

In the preferred embodiment there are five blade stacks 4 with six blades 5 located on each blade stack 4. This means there are 30 effective cutting edges 8 for use in shaving at any one time. Depending on the number of blade stacks 4 and blades 5 located on each blade stack, the number of effective cutting edges 8 for use in shaving will change.

The blades 5 may be rigidly fixed to the shafts 7 using any suitable fixing means. This means that the blades cannot rotate independently of the shafts 7.

Each shaft 7 may also be rigidly fixed to a gear 10 such that when the gear 10 rotates the shaft rotates. Since the blades 5 are rigidly fixed to the shafts 7, rotating the gears has the effect of rotating the blades 5 also. It is preferred that the blades stacks 4 are arranged such that the gear 10 of each blade stack is in engagement with the gear 10 of an adjacent blade stack 4. This creates a gear train, such that when one gear 10 is rotated, all of the other gears 10 in the gear train will rotate.

In use, the exposed cutting edges 8 may become blunt after a period of time. The user may then decide to adjust the razor blades to present a new set of exposed cutting edges 8. There is preferably an input actuator 11 coupled to a primary gear 12. The Primary gear 12 may be engaged with one or more of the gears 10 in the gear train. It is preferred that the primary gear 12 is engaged with the central gear in the gear train, however the primary gear 12 may be engaged with any gear 10 in the gear train. A user may rotate the input actuator 11 in order to effect rotation of the entire gear train. Rotating the input actuator 11 will cause all of the blade stacks 4 to rotate, the input actuator 11 may be rotated until a new set of cutting edges 8 are exposed, and in plane with each other for use in shaving.

To expose a new set of cutting edges 8, the input actuator 11 must be rotated an angle proportional to the number of sides on the blade. I.e. for pentagonal blades, the input actuator 11 must be rotated 72° to expose a new set of cutting edges 8. Similarly, for hexagonal blades, the input actuator 11 must be rotated 60° to expose a new set of cutting edges 8.

There may be an indexing system, to more precisely determine when the input actuator has been rotated sufficiently to expose a new set of cutting edges 8. The indexing system may have a biasing means, to bias the input actuator 11 to index at certain positions that correspond with the effective cutting edges 8 being arranged precisely in a plane and exposed for use in shaving.

The blade stacks 4 are preferably located with the head 3 of the razor such that only the effective cutting edges 8 are exposed from the head at any time. The shafts 7 may index with a corresponding slot 15 located within the razor blade unit 3. The slots 15 allow for the shafts (and blades) to rotate within the razor blade unit 3, while being constrained from movement in other directions.

There may be a space in the razor blade unit 3 and/or the handle 2 for the input actuator 11 to be located. The location of the input actuator 11 as shown in FIG. 1 means it is easily accessible by the user, should the user want to change the cutting edges 8 of the blades.

It is preferred that each cutting edge 8 of each blade 5 is bevelled. Bevelled edges may make the blades 5 more effective at removing hair:

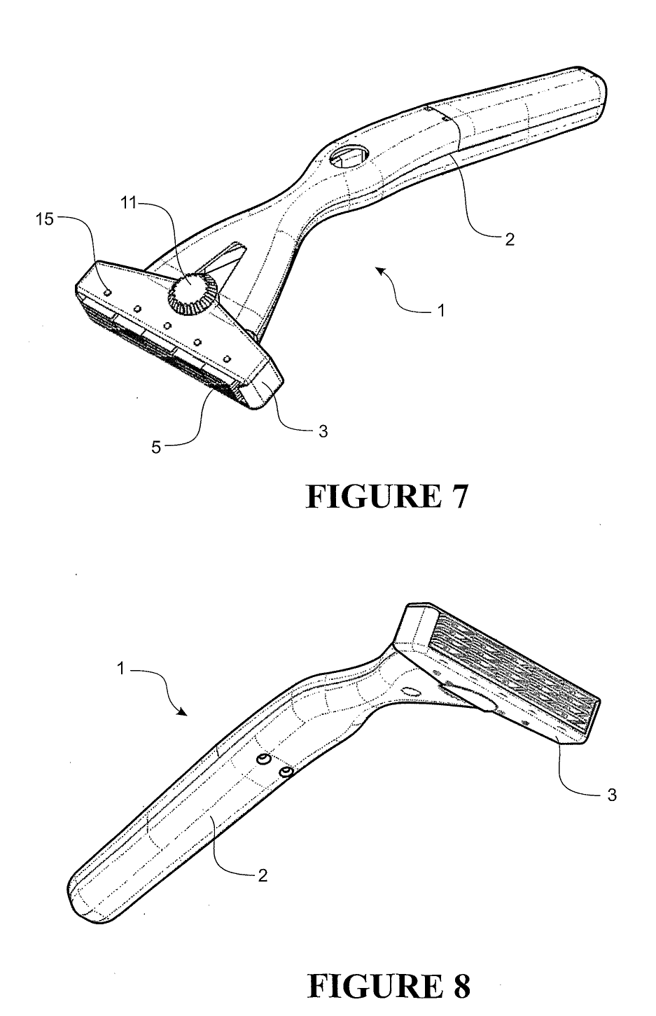

FIGS. 7 and 8 shows an alternative embodiment in which the shaving apparatus 1 has a razor blade unit 3 which contains square blades 5.

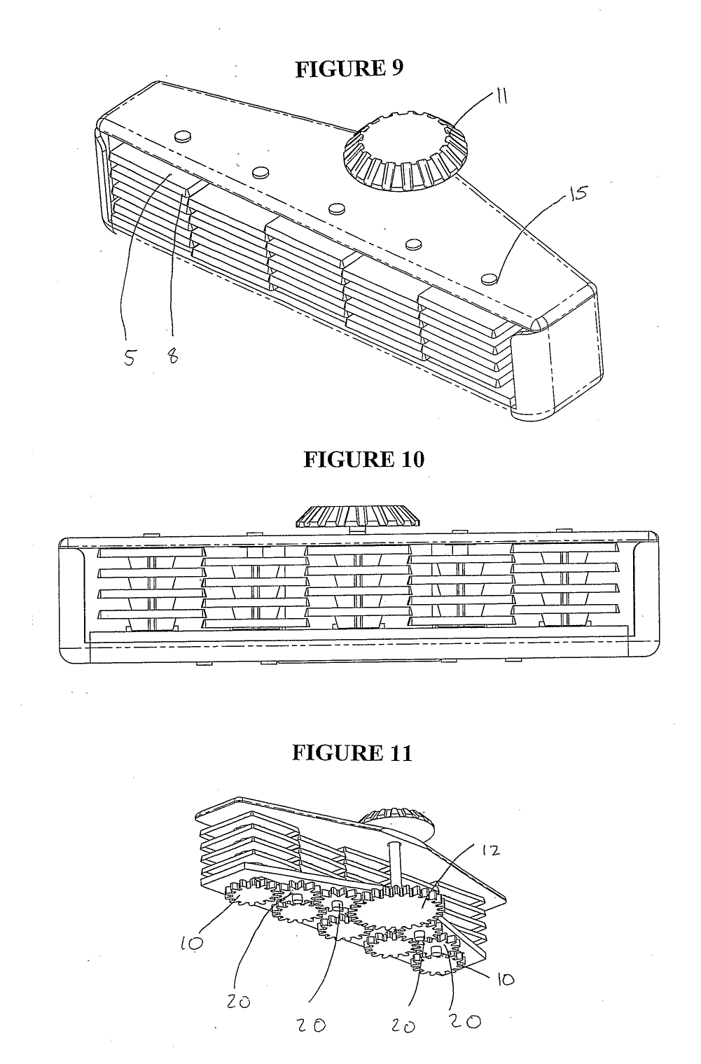

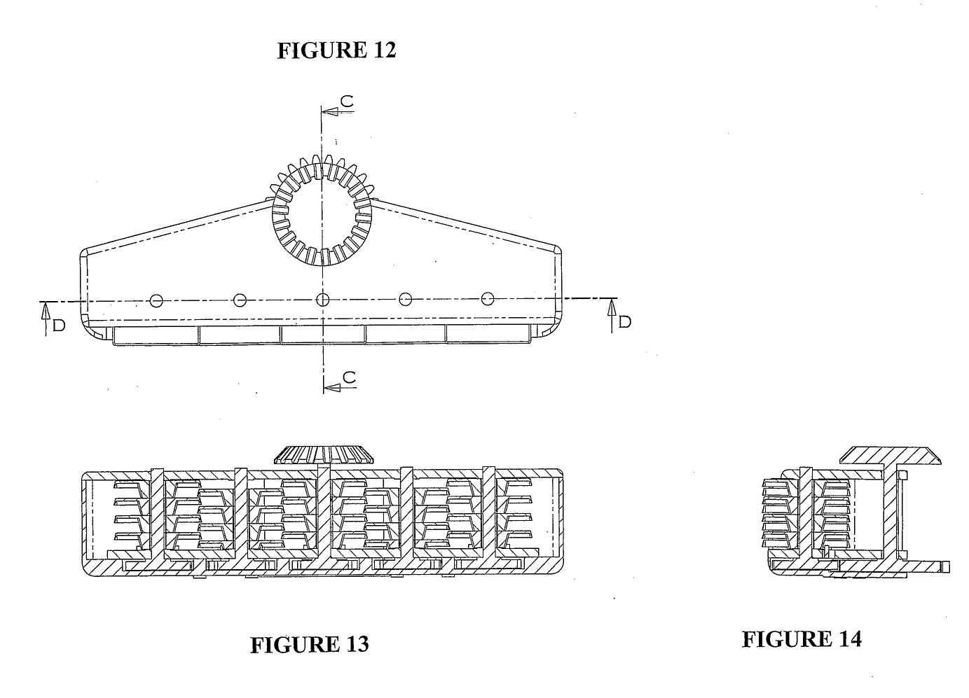

FIGS. 9 and 10 show the razor blade unit 3 with stacks 4 of square blades 5 located in an overlapping relationship.

FIG. 11 shows the gear train of the alternative embodiment of the present invention. A number of intermediate gears 20 may be located on the gear train to transfer rotational torque between the primary gear 12 and the other gears 10.

1.-29. (canceled)

30. A manual shaving apparatus comprising: a plurality of blade stacks, each said blade stack comprises a plurality of identical blades each blade including at least two cutting edges, the blades in each stack are orientated to be in register with each other, and each blade in a stack is arranged to allow rotation about a common axis and to present a cutting edge of each blade in each stack in a common plane.

31. A manual shaving apparatus as claimed in claim 30 wherein an adjuster is provided to simultaneously rotate the blade stacks about their respective axis.

32. A manual shaving apparatus as claimed in claim 31 wherein said adjuster comprises a gear train, and an input actuator.

33. A shaving apparatus as claimed in claim 32 wherein each said blade stack has a gear located thereon, each gear adapted to be rotatable about each said axis.

34. A shaving apparatus as claimed in claim 33 wherein each said gear of each said blade stack is operatively engaged with an adjacent gear of an adjacent blade stack to form said gear train.

35. A shaving apparatus as claimed in claim 34 wherein rotation of one said gear will transfer rotational torque to each said gear located in said gear train,
optionally wherein said input actuator can be rotated by a user to cause said gears in said gear train to rotate.

36. A shaving apparatus as claimed in claim 34 wherein said input actuator can be actuated by a user to cause rotation of said gears on said gear train, wherein, rotation of said gears in said gear train results in rotation of said blade stacks,
optionally wherein said input actuator can be rotated to cause said blade stacks to be rotated to a different orientation.

37. A shaving apparatus as claimed in claim 30 wherein each said blade is polygonal in plan shape,
optionally wherein each said blade has at least three cutting edges.

38. A shaving apparatus as claimed in claim 37 wherein each cutting edge is defined by a side of the polygon of the polygonal shaped blade,
optionally wherein each said blade is pentagonal in plan shape.

39. A shaving apparatus as claimed in claim 30 wherein said cutting edges are bevelled.

40. A shaving apparatus as claimed claim 30 wherein there is a space between each said blade of each said blade stack,
optionally wherein blades in each stack nest within the space between the blades of an adjacent stack.

41. A shaving apparatus as claimed claim 30 wherein the blades in each stack are in an overlapping relationship with blades of an adjacent stack, when viewed in a direction parallel to the common axis,
optionally wherein the stacks of blades are held by a housing and are mounted relative thereto in a rotatable manner each about its respective common axis.

42. A shaving apparatus as claimed in claim 41 wherein the housing holds and each stack of blades and envelops each blade save for at one region of each stack at where one cutting edge of each blade in each stack is exposed and presented to allow the blades to be utilised for shaving.

43. A shaving apparatus as claimed in claim 30 wherein the shaving apparatus is of a disposable kind.

44. A shaving apparatus comprising: a blade stack comprises a plurality of identical razor blades each including at least two cutting edges, wherein each razor blade in said stack is supported by a common axle that is rotatable about an axis of rotation to present a cutting edge of each razor blade in a common plane with a cutting edge of all the other razor blades in the blade stack.

45. A razor blade unit for use in a manual shaving apparatus comprising: a housing that holds a blade stack comprises a plurality of identical razor blades each including at least two cutting edges, each razor blade in said stack supported by a common axle that is rotatable about an axis of rotation relative to the housing to rotate the razor blades in the blade stack in unison to allow sequential presentation of each cutting edge of each razor blade for shaving, in a manner such that a cutting edge of all the other razor blades in the blade stack are presented in a common plane.

46. A disposable razor blade unit for engagement to a manual shaving apparatus handle said disposable razor blade unit comprising:
a. housing,
b. at least one array of planar razor blades arranged on a common axle wherein each razor blade is supported on said common axle parallel to each other and spaced apart from each other, each razor blade including at least at first cutting edge and a second cutting edge, the first cutting edge of each razor blade positioned such that is it located on a plane with which all first cutting edges f each razor blade are coincident, the second cutting edge of each razor blade positioned such that is it located on a plane with which all second cutting edges of each razor blade are coincident,
c. a driver actuable by a digit of a user connected to said common axle whereby the user can rotate said common axle relative to said housing to rotate the array and selectively present one of the first cutting edge and second cutting edge of each razor blade of the array for use in shaving.

47. A disposable razor blade unit as claimed in claim 46 wherein the housing supports said common axle,
optionally wherein a plurality of arrays are provided each arranged on a common axle, each axle mounted relative to said housing parallel to each other, wherein each cutting edge of each array can be positioned to reside in a common plane for presentation for shaving.

48. A shaving apparatus comprising a handle for grasping by a user and a disposable razor blade unit as claimed in claim 46, removably engaged to said handle.

49. As a kit, a shaving apparatus comprising a handle for grasping by a user and a disposable razor blade unit as claimed in claim 46 capable of removable engagement to said handle.
